(19) United States
(12) Patent Application Publication
(10) Pub. No.: US 2008/0128401 A1
(43) Pub. Date: Jun. 5, 2008

(54) Electrical Heating Device

(75) Inventors: Franz Bohlender, Kandel (DE); Michael Zeyen, Herxheim-Hayna (DE)

Correspondence Address: BOYLE FREDRICKSON S.C., 840 North Plankinton Avenue, MILWAUKEE, WI, 53203, US

(73) Assignee: CATEM GmBH & CO. KG, Herxheim Bei Landau (DE)

(21) Appl. No.: 11/946,603

(22) Filed: Nov. 28, 2007

(30) Foreign Application Priority Data
Nov. 30, 2006 (EP) 06024835.5

(51) Int. Cl. F24H 3/04; H05B 3/06; B60L 1/02

(52) U.S. Cl. 219/202; 392/465; 392/487

(57) ABSTRACT

An electrical heating device for a motor vehicle has a layer structure held by a retaining device. The heating device has several heat generating elements and heat dissipating elements between the heat generating elements, and a control device for controlling the heat generating elements. The heating device has a sound deadening housing, which circumferentially encloses the control device and by which sound waves produced by the control device are deadened. Through this measure, disturbing exposure of persons located in the vehicle to structure-borne noise and/or to sound waves borne by the air flowing through the electrical heating device is prevented.

### BACKGROUND OF THE INVENTION

1. Field of the Invention

The present invention relates to an electrical heating device, in particular for a motor vehicle with a layer structure held by a retaining device, comprising several heat generating elements and between these said elements heat dissipating elements and a control device for the control of the heat generating elements.

2. Description of the Related Art

An electrical heating device of this nature is for example known from EP 1 691 579 which originates from the applicant.

The individual layers of the layer structure can with heating devices with corresponding conformity be glued together and/or pressed together under pretension from a spring, in particular when the layer structure is accommodated in an enclosed frame which forms the retaining device. Single electrical heat generating elements are held insulated from one another in the retaining device and generally, on a face side of the layer structure, for example in the longitudinal direction of the layer structure, are provided with electrical contact elements, via which certain heat generating elements can be electrically connected to the vehicle electrical system.

For forming the heat generating elements normally resistance heating elements, so-called PTC heating elements, are used with which overheating of the heat generating elements can be reliably prevented due to their control characteristic. Each heat generating element usually comprises several PTC heating elements arranged one behind the other in the longitudinal direction of the layer structure. Said heating elements lie flat on an electrically conducting and generally well thermally conducting surface, via which the heat generating elements are supplied with electrical energy and the heat generated is dissipated by thermal conduction. This flat surface is normally formed by the heat dissipating elements, which for this purpose have on their outer side a sheet metal band which contacts a heat generating element and which is connected as a separate component or integrally with heating ribs or plates essentially extending transverse to the layer structure. Where the flat surface is formed by flat sheet metal bands, they are generally assigned to the heat generating elements. The sheet metal bands can in this respect form a prefabricated unit with the PTC heating elements.

For the open or closed-loop control of the electrical heating device it has a control unit which controls the heat generating elements. The control device can here comprise electronic control elements and/or conventional relays.

Following the general trend in the automotive industry, the electrical heating devices for motor vehicles are also prepared as modules which often means that the control device is mounted on the retaining device as part of the electrical heating device or is at any rate arranged adjacent to it. Thus, it is known for example from EP 1 157 867 that a control device for the control of the heat generating elements can be arranged within the frame and formed using power transistors, which have cooling fins on the side facing the layer structure. A similar arrangement is known from EP 1 492 384, which can similarly be regarded as forming a generic class and in which the control device is accommodated in the frame and similarly formed by power transistors. Also here there is the necessity of dissipating the heat loss produced by the transistors to the air flowing through the electrical heating device so that the control device is provided within the retaining device. An alternative design solution is known from EP 1 691 579 mentioned in the introduction, in which the control device is accommodated in a separate housing at the side of the frame and is mainly formed from switching relays which do not dissipate any loss.

The arrangement of the control device in the retaining device or adjacent to the retaining device particularly with mounting of the control device directly on the retaining device has the problem in that noises produced during switching can penetrate relatively easily into the passenger compartment with the conveyed air where they can be heard by the passengers in the motor vehicle. Sounds produced by the control device can however also for example be passed into the interior as structure-borne noise via the walls of the ventilation ducts. In this case even relatively slight acoustic disturbances produced by the control device can be amplified by the walls in the hollow ventilation ducts, so that acoustic disturbance of the occupants of the vehicle is not only to be expected when traditional mechanically switching relays in the control device switch.

### OBJECT OF THE INVENTION

The object of the present invention is to reduce the effect of disturbing acoustic noise on the occupants of the vehicle.

This object is solved according to the invention by an electrical heating device with the features of claim 1.

Preferred further developments are given in the dependent claims.

With the electrical heating device according to the invention the control device is essentially surrounded by a circumferentially closed sound deadening housing. This sound deadening housing can completely or almost completely circumferentially enclose the control device and is formed such that sound waves emanating from the control device are at least partially absorbed. In this respect both those sound waves are preferably absorbed which otherwise propagate as structure-borne noise as well as those which are carried along by the air flowing through the electrical heating device. The sound deadening housing should be formed such that sound waves produced by the control device are preferably absorbed directly at the control device. The electrical heating device according to the invention has proved to be particularly effective with embodiments with which the control device is arranged at the side on the retaining device and is joined to it. In particular with these embodiments there is the problem that sound waves penetrate relatively unhindered to the occupant cell through structure-borne noise and through the air passing through the electrical heating device.

Further advantages and details of the invention are given in the following description of an embodiment in conjunction with the drawing. This shows the following:

### BRIEF DESCRIPTION OF THE DRAWINGS

FIG. 1 a perspective side view of the embodiment;

FIG. 2 a perspective exploded illustration of the housing of the embodiment enclosing the control device;

FIG. 3 a perspective plan view of a housing element of the housing according to FIG. 2;

FIG. 4 a perspective plan view of an internal housing of the embodiment illustrated in the FIGS. 1-3 and

FIG. 5 a plan view of the inner housing illustrated in FIG. 4 from the other side.

### DETAILED DESCRIPTION OF THE PREFERRED EMBODIMENT

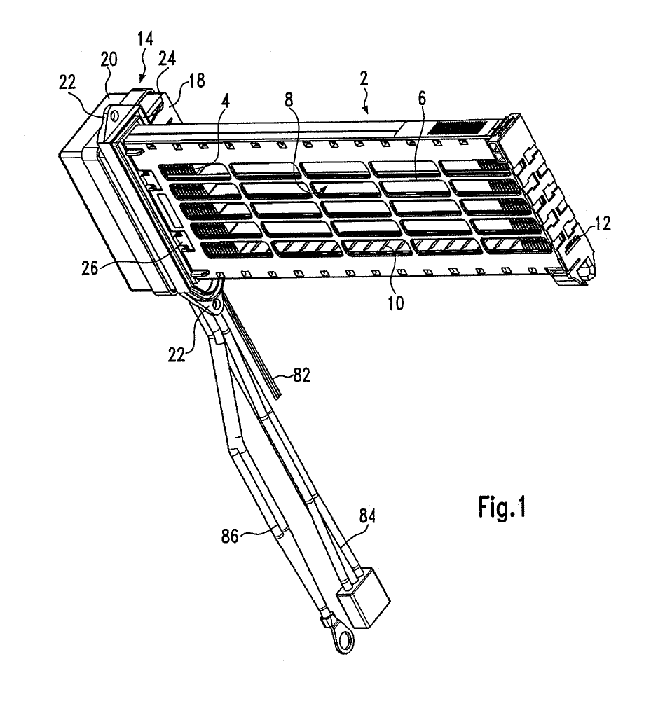

FIG. 1 illustrates the main parts of the electrical heating device. This comprises a two-part plastic housing 2, in which a layer structure with several heat generating elements and intervening heat dissipating elements are held and pretensioned by a spring device described in more detail in the following. The heat dissipating elements 4 can be seen as meandering, curved sheet metal strips. Between said strips and behind longitudinal struts 6, which pass through a housing opening 8 formed by the plastic housing 2, there are heat generating elements running parallel to the longitudinal struts 6 and which cannot be recognized. In the central region of the housing opening 8 the layer structure has been removed and a spring strip 10 can be seen from which spring webs protrude inwardly. The spring strip 10 is introduced through an insertion slot 12 formed on the face side, as is described in EP-A-1 432287 which originates from the applicant.

On the plastic housing 2 enclosing the layer structure a sound deadening housing 14 is arranged on the face side. The sound deadening housing 14 comprises essentially a second housing element accommodating a control device 16 and a first housing element arranged between it and the plastic housing. The first housing element is labeled with the reference numeral 18, the second housing element with the reference numeral 20. The first housing element 18 is joined both to the second housing element 20 and also to the plastic housing 2.

The first housing element 18 has on its underside facing the plastic housing flange segments 22 with holes for mounting the embodiment on the ventilation duct of a motor vehicle. Furthermore, the first housing element 18 forms on its underside a circumferential sealing groove 24 which interacts with ridges formed on the ventilation duct in order to seal the plastic housing 2, which is pushed into the ventilation duct which it transversely passes, to the outside. From the underside of the first housing element 18 single-part, T-shaped latching tongues 26 also protrude down, which are latched with the plastic housing 2.

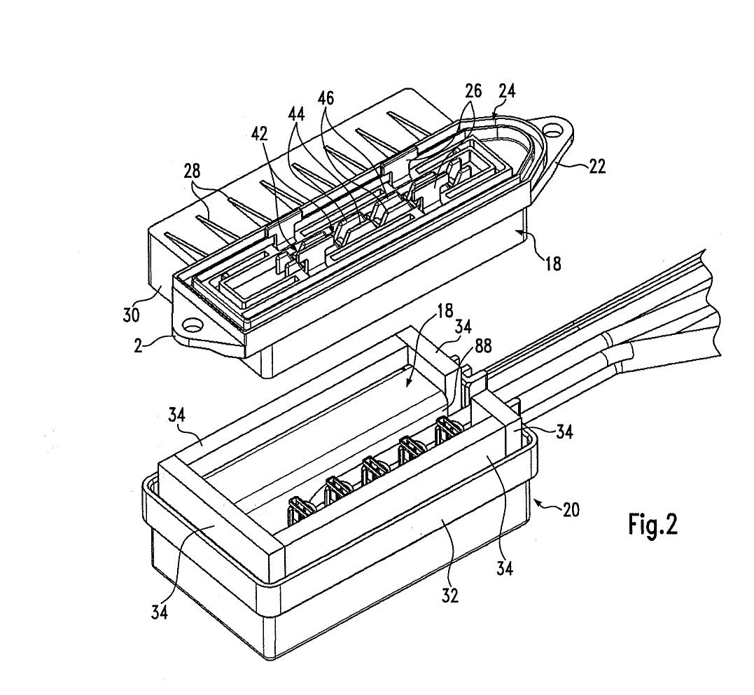

On the upper side facing away from the underside the first housing element 18 forms a single-part housing cover 30 with a rectangular base area (FIG. 2), said housing cover being formed by reinforcing ribs 28 and stiffened opposite the flange segments 22.

This housing cover 30 fits between a collar 32 running externally around the second housing element 20 and sound deadening plates 34, accommodated in the second housing element 20 and protruding from it. Apart from the sound deadening plates 34, which can be seen in FIG. 2 and which circumferentially clad the interior of the sound deadening housing 14, further sound deadening plates can be provided on the inner side of the housing cover 30 or on the bottom of the second housing element 20. With the illustrated embodiment the bottom of the second housing element 20 is nevertheless not occupied with a deadening plate 34 and has a design which is described below. The housing cover 30 can have a sound deadening plate which is closely located to the face sides of the circumferentially provided sound deadening plates 34.

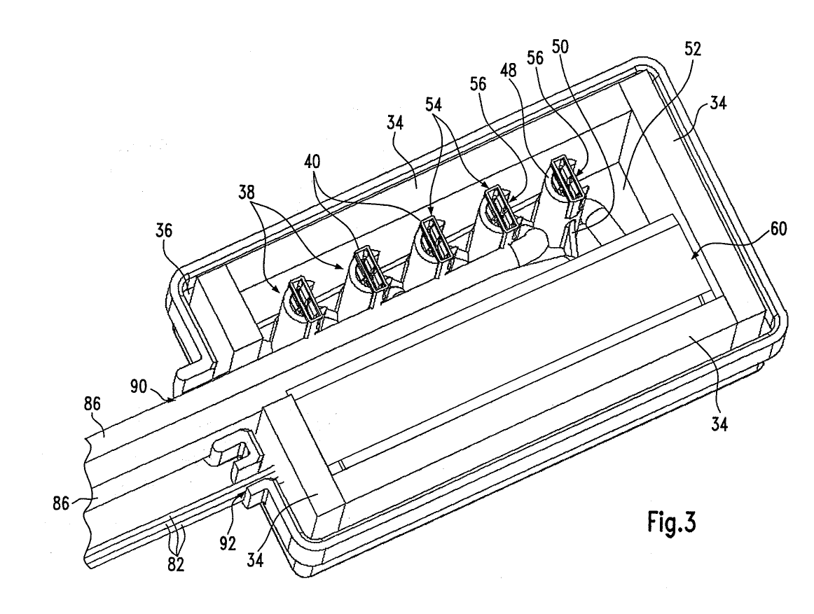

The sound deadening plates 34 are cut from a foam plastic with a relative high density and precisely fitted into the second housing element 20. In the illustrated embodiment the sound deadening plates 34 have a thickness of between 4 mm and 6 mm, preferably a thickness of 5 mm. As further measures in the sound deadening encapsulation of the interior of the sound deadening housing 14, a sound deadening layer is provided between the collar 32 and the circumferentially arranged sound deadening plates 34, for example in the form of an inlaid seal or in the form of a sound deadening element formed by means of two-component injection moulding on the first or second housing element 18, 20, said sound deadening element being provided according to a type of sealing lip preferably on the face side on the housing cover 30 or on a sealing edge 36 of the second housing element 20 which can be seen in FIG. 3, surrounded circumferentially by the collar 32. Through this sound deadening layer, the two housing elements 18, 20 are brought together in a soundproof manner.

As can be seen from FIG. 3, holders 38 for electrically conducting contact springs 40 protrude from the bottom 52 of the second housing element 20. Contact lugs electrically connected with the individual heat generating elements engage in these contact springs 40, said contact lugs being formed regularly by sheet metal bands, which at any rate partially form a locating face for the PTC heating elements and are brought out at the side via the face side of the plastic housing 2. To achieve this, the first housing element has slot-shaped insertion openings 42, which are illustrated in FIG. 2, to which transversely broken up longitudinal webs 44 are recessed, single part, on the underside of the first housing element 18, their conically running web edges 46 leading hopper-shaped to the insertion openings 42, thus easing the introduction of the contact lugs into the insertion openings 42. As can be seen from the illustration in FIG. 3, the holders 38 are formed by slotted tubes 48, which are stiffened at the base by reinforcing ribs 50 against the bottom 52 of the second housing element 20. These tubes 48 have a transverse slot 54 which is formed in an extension of the reinforcing ribs 50 and which only partially passes through the slot 48. Furthermore, the tubes 48 have a cable slot 56 cut out at right angles to this, which extends down to the vicinity of the bottom 52.

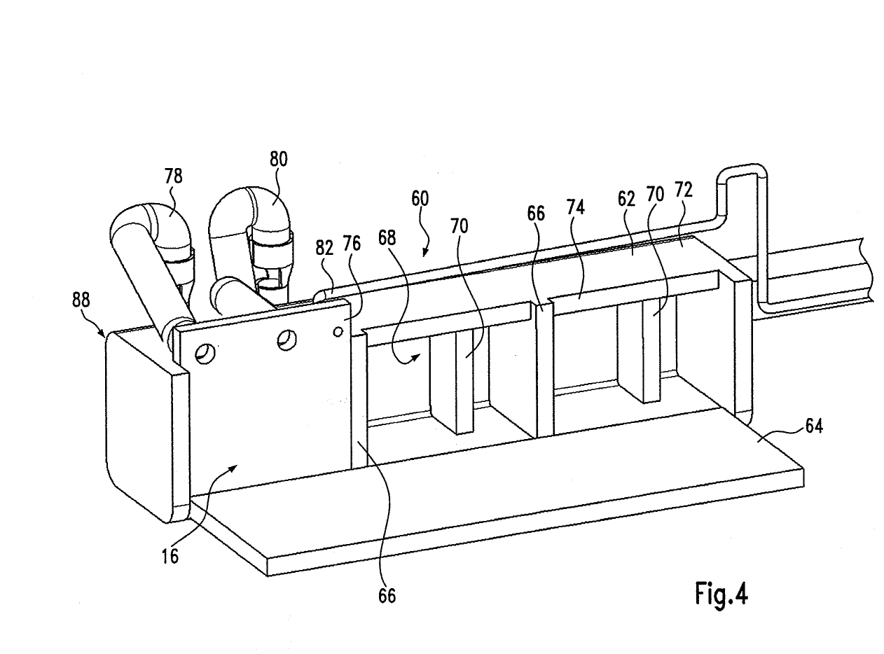

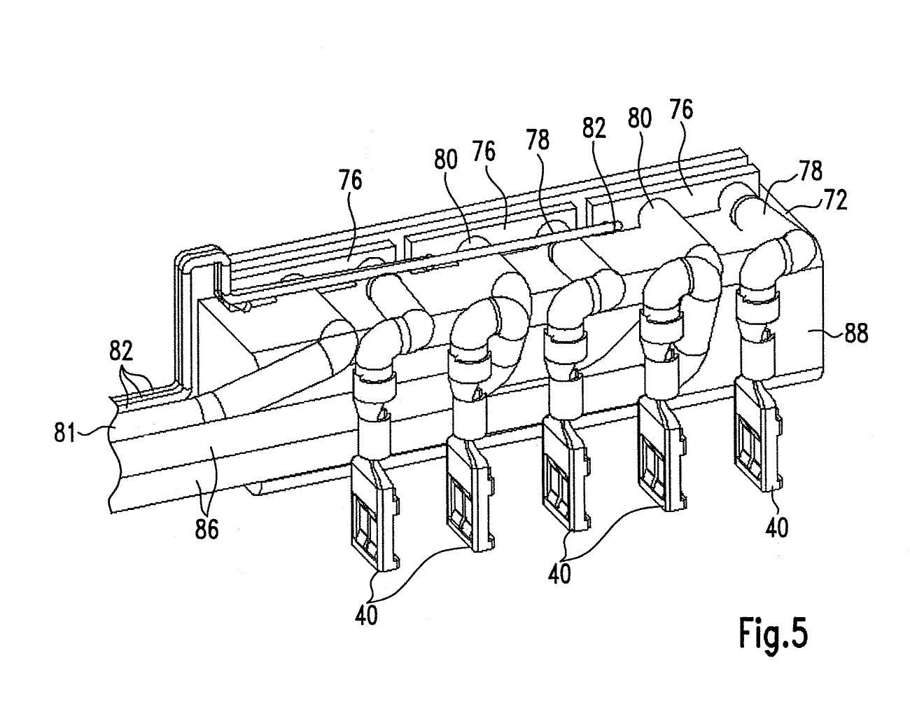

In the second housing element 20 an inner housing 60 is inserted which is illustrated in more detail in FIGS. 4 and 5. The inner housing is preferably formed from a sound deadening material and is for example an injection molded part in a foamed plastic. The inner housing 60 has an inner housing base 62, which has a cross-section of essentially a U-shape and to which an inner housing cover 64 is supported for swiveling. The inner housing base 62 forms three control element accommodation spaces 68, separated by partition walls 66. Each control element accommodation space 68 can have further sound deadening partition walls, which are shown as examples in FIG. 4 and are identified with reference numeral 70. The face side of a side wall 72 of the inner housing base 62 forms locating faces 74 for circuit boards 76, which are protruded beyond by the partition walls 66 extending at right angles to them and are separated from one another by them. On these locating faces 74 the circuit boards 76 are located of which in FIG. 4 only one circuit board 76 is shown as an example. The other circuit boards have been omitted in the illustration.

It can be seen that the face side of the partition walls 66 and the upper side of the circuit board 76 are at about the same height. The closed inner housing cover 64 is located on this surface. The circuit board 76 and the inner housing cover 64 protrude beyond the side wall 72. This protruding part of the circuit board 76 is used for the connection of electrical connecting leads 78, 80 and control leads 82. Control elements, for example relays, which cannot be seen in the figures, protrude from the inner side of the respective circuit boards 76 into the control element accommodation spaces 68. The control elements for each circuit board 76 are in each case accommodated in a control element accommodation space 68 separated by the partition walls 66 and which is divided by the other partition walls 72.

The connecting leads 80 leading to the circuit boards 76 are formed by extensions of a central feeder cable 84. The further ground leads 86 lead to the inner housing 60. These ground leads 86 and the connecting leads 78 leaving the circuit boards 76 each have one contact spring 40 at the end in each case, which is electrically connected to the corresponding leads 78, 86. The leads 78, 80 connected to the circuit boards 76 initially extend essentially parallel to the side wall 72 and are then passed in front of a further side wall 88 which transversely passes through the housing 14 in the fitted state.

As can be seen particularly in FIG. 5, the circuit boards 76 protrude beyond the respective connecting leads 78, 80 at the connection point. Furthermore, the inner housing cover 64 at this point protrudes beyond the inner housing 60 as well as the circuit boards 76. The embodiment of an inner housing 60 illustrated in FIG. 5 can be formed as a pre-assembled component. In this respect it is sufficient if the inner housing cover 64 is located on the circuit boards 76. It is in particular not necessary that the inner housing cover 64 is fixed with respect to the inner housing base 62. Fixing of this nature can however be realized with the prefabricated component.

For mounting the inner housing 60 on the second housing element 20 this has a receptacle provided on the bottom 52 into which the protruding edge of the inner housing cover 64 can be fitted as also the ends of the circuit boards 76 on insertion into the housing 14. In this arrangement illustrated in FIG. 3 the inner housing cover 64 is located on the assigned sound deadening plate 34. The pre-assembled inner housing 60 contacts the bottom 62 formed from plastic only via the face side of the inner housing cover 64, which is formed from a sound deadening material. The sound deadening material is a silicone-free plastic, preferably a relative soft plastic, such as for example polyurethane, which ensures a certain deadening support of the inner housing 60 via the material forming the inner housing 60. A polyurethane plastic with a hardness of ASHORE A between 50 and 90 has proven practicable. The receptacle is dimensioned such that the inner housing cover 64 fits precisely into the receptacle with the circuit boards 76. Optionally, with slight compression of the sound deadening material of the inner housing cover 64, a press fit can also be realized so that the inner housing 60 is fixed to the sound deadening housing 14 via the receptacle. The receptacle can for example be formed by recesses, ribs, webs or similar features on the bottom 52 by means of injection moulding as a single part on the housing 14. Alternatively, it is possible to form a receptacle by single and/or between single sound deadening plates 34.

During the assembly of the embodiment, first the prefabricated component is inserted into the second housing element 20. Then the contact springs 40 are pushed into the respective transverse slots. While doing so, the connecting leads 78 or the ground leads 86 are pushed into the cable slot 56 where they are accommodated.

A first cable opening 90 is cut out on the second housing element 20 for bringing out the leads 80 or 86; a second cable opening 92 is cut away for the control leads 82. The two openings 90, 92 are each covered on the upper side by the first housing element 18 and thus simplify the insertion of the respective leads 80, 82, 86.

The embodiment presented above has the advantage that the individual circuit boards 76 are accommodated with the associated control elements in separate control element accommodation spaces. The situation is avoided in which a common circuit board for all control elements of the control device is provided which as a resonating body would unnecessarily amplify emitted sounds. Since the inner housing 60 is formed with the associated circuit boards 76 and the leads 78, 80, 82, 86 connected to it as a prefabricated component, this component can first of all be prefabricated and the sensitive control elements sealed by fitting the inner housing cover 64 onto the inner housing base 62. With the ensuing mounting of the prefabricated component on the sound deadening housing 14 the control elements are thus protected from impact. Also, the circuit board is prevented from becoming contaminated on its sensitive sections. The circuit board 16 is only free at its section protruding from the inner housing base 62, which has no sensitive electrical or electronic regions. Due to the receptacle formed on the second housing element 20 for inserting the prefabricated inner housing 60, the inner housing and the sound deadening housing 14 can be easily joined.

Since the sound emitting control elements are on one hand enclosed by the inner housing and on the other hand supported in a sound deadening manner by the inner housing cover 64 with respect to the sound deadening housing 14 and furthermore are surrounded by the sound deadening plates 34, the best possible sound insulation is achieved. The propagation of sound is in particular also reduced by an airtight sealing of the housing. In this respect, the flat plug contacts introduced into the housing 14 from the radiator are for example passed through a lip seal formed by means of two-component injection moulding. Using appropriate seals, the openings 90 or 92 can also be provided with sealing for the passage of the leads 80, 86, the said sealing being formed on the housing 14 by means of two-component injection moulding.

The special design of the tubes 48 facilitates a simple and precisely fitting assembly of the contact springs 40 introduced with the prefabricated component. The design also facilitates automatic insertion of the contact springs 40 into the tubes 48.

A subunit of the control device 16 is then accommodated in each of the control element accommodation spaces 68. Each of these control subunit devices, separately accommodated in the inner housing 60, is in itself soundproofed. The control subunit devices control by open or closed-loop preferably proportionally the complete heating power of the electrical heating device. With the illustrated embodiment three control subunit devices are provided, which then each control one third of the heating power of the whole heating device. In this way a better adaptation of the electrical energy consumed by the electrical heating device to a generator power of the motor vehicle can be achieved. The electrical heating power can with the illustrated embodiment then be switched to one third, two thirds or three thirds of the maximum heating power. Taking into account the switching capacity of the relays, the heating power of the switching circuits can be designed however different one to the other. The grading of the respective heating powers of a single switching circuit should here be selected such that the whole heating power can be switched in the smallest possible stages, despite the division giving just three switching circuits, using elaborate on/off switching of the individual switching circuits. With the illustrated embodiment only relays are used as the control element.

1. An electrical heating device with a layer structure held by a retaining device, said layer structure comprising several heat generating elements and heat dissipating elements arranged between them; and a control device which controls the heat generating elements and which is surrounded by an essentially circumferentially enclosed housing,
wherein
the control device is supported, with sound deadening elements as an intermediate layer, in the housing.

2. The electrical heating device according to claim 1, wherein the housing comprises a first housing element provided with a mount for mounting the housing to the retaining device and a second housing element which is joined to said first housing element and which accommodates the control device so that the control device is supported in a soundproof manner.

3. The electrical heating device according to claim 2, wherein the housing elements are located opposite one another with an intervening sound deadening layer between them.

4. The electrical heating device according to claim 2, wherein the second housing element is cladded with sound deadening plates.

5. The electrical heating device according to claim 4, wherein, within one of the accommodation spaces of the sound deadening housing provided by sound deadening plates, at least one inner housing holding the control device is accommodated.

6. The electrical heating device according to claim 5, further comprising at least one circuit board with control elements mounted on it, wherein the inner housing is formed in a sound deadening manner and that at least one circuit board covers a control element accommodation space formed by the inner housing.

7. The electrical heating device according to claim 6, further comprising several separately controllable heating blocks comprising at least one heat generating element and separate control devices assigned to these heating blocks, and wherein the control devices are formed by control subunit devices held soundproofed from one another.

8. The electrical heating device according to claim 7, wherein separate control element accommodation spaces are provided for each control subunit device, wherein each control subunit device is covered by the circuit board assigned to the control subunit device, and wherein the circuit boards are spaced from one another by a partition wall protruding beyond a locating face for the circuit board, formed by the inner housing.

9. The electrical heating device according to claim 7, further comprising an inner housing cover which covers a rear side of the circuit boards which is free of control elements.

10. The electrical heating device according to claim 9, wherein the inner housing cover contacts the at least one partition wall, and wherein the circuit board protrudes beyond the inner housing for the connection of at least one of a connecting lead and a control lead.

11. The electrical heating device according to claim 9, wherein the inner housing cover protrudes beyond the circuit board, at least at its section where it protrudes beyond the inner housing, and wherein the circuit board and the inner housing cover engage at the end in a receptacle formed by the sound deadening housing.

12. The electrical heating device according to claim 9, wherein the inner housing cover is supported for swiveling on the inner housing, and wherein the control device with the at least one of the connecting lead and the control leads attached to it together with the inner housing cover, are formed as a prefabricated component.

13. The electrical heating device according to claim 10, wherein the second housing element has holders for contact springs connected to each of the connecting lead leaving the control device at the end, in which the contact springs can be pushed, and wherein, on the housing element corresponding to the holders insertion openings, cut outs are provided through which the contact springs can be pushed and to which to the heat generating elements can be electrically connected.

14. The electrical heating device according to claim 13, wherein the holder is formed by a slotted tube, which protrudes from the bottom of the second housing element and which is formed in one part on the second housing element.

15. An electrical heating device for a motor vehicle, comprising:
a layer structure held by a retaining device, the layer structure comprising several heat generating elements and heat dissipating elements arranged between them;
a control device for the control of the heat generating elements; and
a housing which circumferentially encloses the control device,
wherein the control device is supported in the housing with sound deadening elements as an intermediate layer.

16. The electrical heating device according to claim 15, wherein the housing comprises a first housing element provided with mounts for mounting the housing to the retaining device and a second housing element which is joined to the first housing element and which accommodates the control device in a soundproof manner.

17. The electrical heating device according to claim 16, wherein the housing elements are located opposite one another with an intervening sound deadening layer between them.

18. The electrical heating device according to claim 16, further comprising sound deadening plates that clad the second housing element.

19. The electrical heating device according to claim 18, wherein accommodation spaces are formed between the sound deadening housing plates, and wherein at least one inner housing that holds the control device is accommodated in one of the accommodation spaces.

20. The electrical heating device according to claim 19, further comprising at least one circuit board with control elements mounted on it, wherein the inner housing is formed in a sound deadening manner, and wherein that at least one circuit board covers a control element accommodation space formed by the inner housing.
